(19) United States
(12) Patent Application Publication
(10) Pub. No.: US 2016/0292573 A1
(43) Pub. Date: Oct. 6, 2016

(54) A METHOD FOR DETECTION AND CHARACTERIZATION OF TECHNICAL EMERGENCE AND ASSOCIATED METHODS

(71) Applicant: BAE SYSTEMS INFORMATION AND ELECTRONIC SYSTEMS INTEGRATION INC., Nashua, NH (US)

(72) Inventors: Olga BABKO-MALAYA, Winchester, MA (US); Daniel B. HUNTER, Woburn, MA (US); Andrew C. SEIDEL, San Francisco, CA (US); Michelle A. TORRELLI, Chelmsford, MA (US)

(21) Appl. No.: 15/035,555

(22) PCT Filed: Sep. 8, 2015
(86) PCT No.: PCT/US2015/048911

§ 371 Date: May 10, 2016

Related U.S. Application Data
(60) Provisional application No. 62/048,573, filed on Sep. 10, 2014.

(51) Int. Cl. G06N 5/02; G06N 7/00; G06F 17/30

(52) U.S. Cl. CPC G06N 5/022; G06F 17/30011; G06F 17/3053; G06N 7/005

(57) ABSTRACT

The present invention is a method for constructing a knowledgebase that can provide analysis and trend prediction of emerging technologies. Metadata and full text are gathered from collections of documents, which can include more than 10 million documents, and are used to build a heterogeneous network of elements related to themes such as technical emergence. Indicators and models are selected that identify network characteristics and trends of interest. The indicators can be derived by applying a combination of citation analyses, natural language processing, entity disambiguation, organization classification, and time series analyses. A metric can be used to evaluate indicator utility. A framework can be sued to generate and validate the indicators. The models can be derived using an automated process. Upon receipt of a query, the indicators and models can be used to apply a scoring process to extracted features to predict a future prominence of an entity.

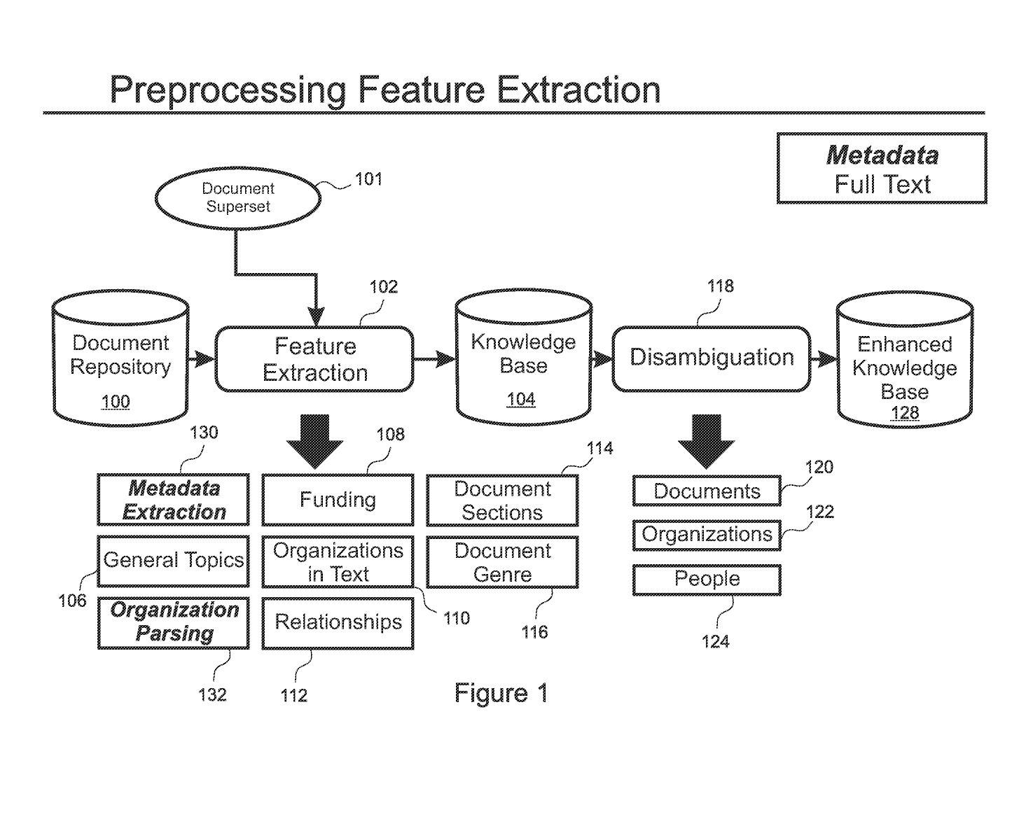

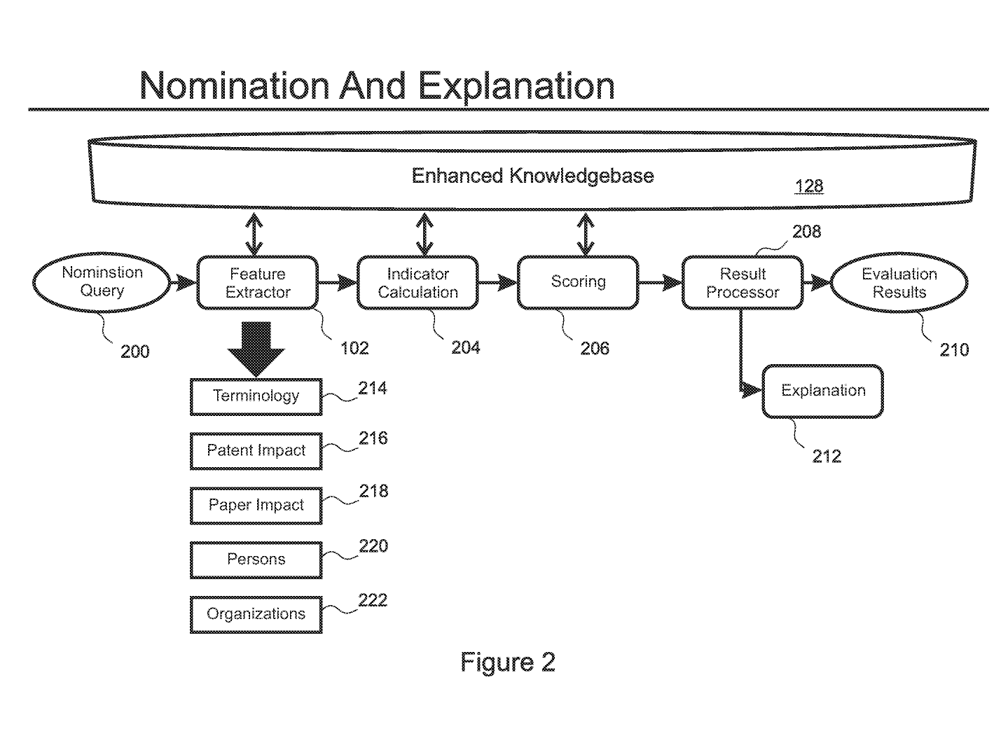

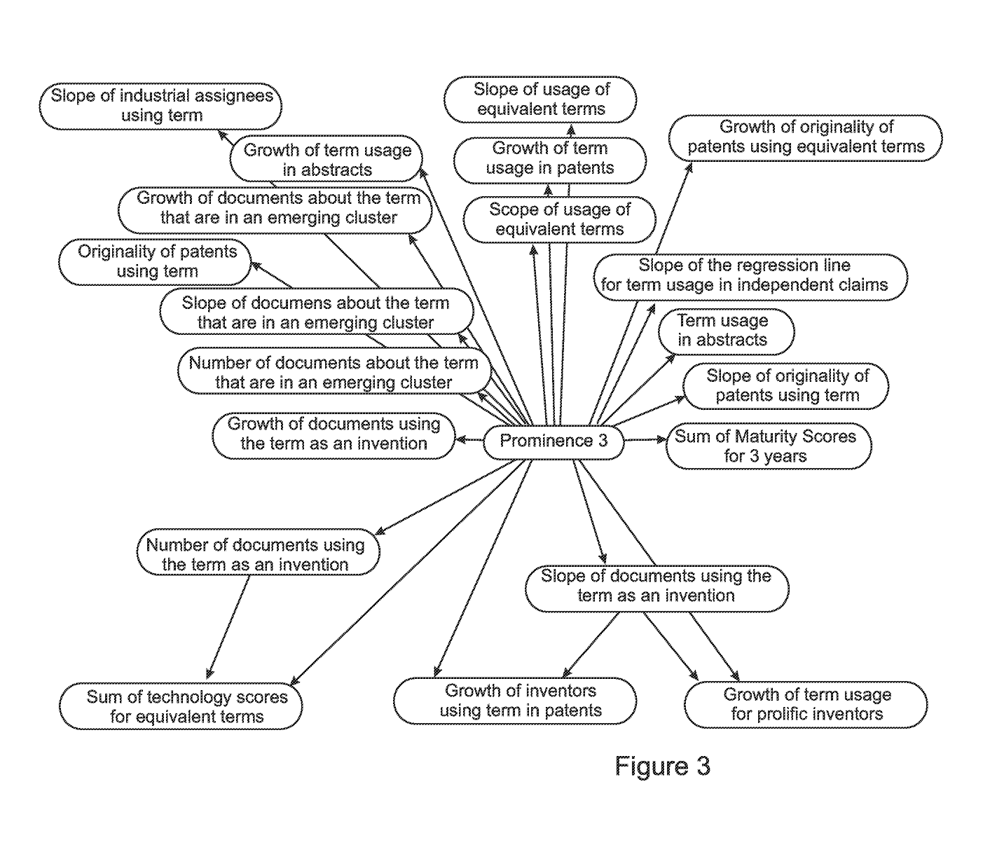

### RELATED APPLICATIONS

This application claims the benefit of U.S. Provisional Application No. 62/048,573, filed Sep. 10, 2014, which is herein incorporated by reference in its entirety for all purposes.

### STATEMENT OF GOVERNMENT INTEREST

This invention was made with United States Government support under Contract o. D11PC20154 awarded by the United States Department of the Interior. The United States Government has certain rights in this invention.

### FIELD OF THE INVENTION

The present invention relates to the processing of data, and more particularly to analysis of scientific and patent literature metadata and text for assessing technical emergence.

### BACKGROUND OF THE INVENTION

The ability to predict emergence of new ideas, trends, and topics has broad implications for many different stakeholders, including scientists deciding which subjects of research to pursue, government agencies deciding which programs to support, companies choosing where resources should be focused, investors selecting which technologies to fund, and intelligence analysts monitoring where the most interesting technologies are being developed.

Predictions of this nature are generally made by “experts” and other analysts having skill and knowledge in various fields, based on their review of available data, including publically available documents such as patents and technical papers. However, predictions made in this way can be inherently unreliable, due to gaps in the knowledge of such analysts, limits to the quantity of information that an analyst can reasonably review, and any predispositions that an analyst may have based on individual experience and interests.

Once a trend or topic of interest has been identified, automated tools are available that can be used to search for relevant information. The prior art discloses a number of methods for analyzing documents, including patents as well as technical and/or scientific literature, so as to retrieve information regarding topics/technologies of interest.

U.S. Pat. No. 6,151,600, for example, teaches that information may be appraised electronically. According to this approach, electronic data is stored on a data server, requests for information are sent to this data server based on search criteria, and matching results are returned. This system also includes a metering server that enables the retrieval of data from the electronic database.

In another approach, U.S. Pat. No. 7,668,885 teaches that data may be compiled into a computer-based adaptive knowledge system for immediate use in analysis. The knowledge system is created by modifying, individualizing, and prioritizing a database according to third-party metadata, personality, and preference characterization. The system thereby compiles data of interest to the user, categorizes the data, and organizes the data into selectable infrastructures.

However, these methods are limited to locating patents or other documents that match specified search criteria that is input by a user. This requires that the user must have already determined by some other means what trend, topic or technology area is of interest, before documents and other information relating to that trend, topic, or technology area can be sought and located.

Other methods attempt to identify trends and topics of interest by applying citation analysis to a database of compiled documents, for example by analyzing papers and researchers based on citation frequency, patterns, and graphs of citations. However, these tools are limited to citations, and cannot extract and summarize information discussed in the full text of the documents themselves.

Accordingly, there is a need for an improved method for achieving a complete characterization of a knowledge base, including full text data as well as citations and metadata, so as to enable automatic identification of emerging technologies and other trends and topics that may be candidates for further research and monitoring.

### SUMMARY OF THE INVENTION

The present invention is a method for achieving a complete characterization of a knowledge base, including full text data as well as citations and metadata, so as to enable automatic identification of emerging technologies and other trends, and topics that may be candidates for further research and monitoring. In various embodiments, the disclosed method is able to distil information from very large databases, and is customizable to various tasks, including prediction of emerging scientific topics and technologies.

Specifically, the present invention is a method for creating a knowledge base based on metadata and full text extracted and distilled from collections of data, whereby the method comprises the steps of using said data to build a heterogeneous network of elements related to emerging technologies and other trends, and selecting indicators and models to identify network characteristics and trends of interest to users, whereby information regarding emerging technologies and trends may be distilled from said data.

In embodiments, information is gathered, including metadata and full text, from collections of scientific articles and patents. In various embodiments, tens of millions of documents can be processed. The extracted information is then used to build a heterogeneous network of elements related to an analysis of technical emergence. Indicators and models are then selected to identify network characteristics and trends that are of interest to users. In embodiments, a framework is employed for generation and validation of a large number of indicators. These indicators are derived by combining citation analyses, natural language processing, entity disambiguation, organization classification, and time series analyses. Embodiments of the invention employ an automated process for model selection and training, as well as various metrics for evaluating the utility of indicators. These evaluations can include making predictions about new scientific topics and technologies relative to mature topics that have significant histories.

The present invention enables the extraction of data from full text as well as by citation analysis. Furthermore, the method of the present invention includes a framework that allows it to easily adapt to different user needs, and to various domains of application such as medical, defense, and others. As a result, the present invention is customizable to the data set, and may be used for a variety of applications. In particular, it should be noted that, while many of the examples and explanations given herein are directed to detecting the emergence of technical trends and new technologies, the disclosed method is not limited only to technological fields, but is also applicable to the detection of emerging trends and topics of interest in law, politics, fashion, entertainment, art, literature, and many other fields of interest.

The present invention is a method for constructing a knowledgebase that is useful for providing analysis and predictions based on a collection of data. The method includes obtaining a collection of data, extracting features from said data, at least one of said features being extracted from full text included in said data, applying disambiguation to said extracted features, using said collection of data and extracted features to build a heterogeneous network of elements related to at least one designated theme, and deriving indicators and models from said network of elements that identify network characteristics and trends characteristic of said collection of data, wherein said collection of data, extracted features, heterogeneous network of elements, indicators, and models are configured as a knowledgebase that is suitable for providing analysis and predictions based on the collection of data.

In embodiments, the collection of data includes a plurality of documents. In some of these embodiments, the documents in the collection of data are obtained from at least one of a document repository and a document superset. In other of these embodiments, the documents include patents and papers. In still other of these embodiments, the documents are represented in an extensible markup language (XML) format. In yet other of these embodiments, the collection of data includes at least ten million documents.

In any of the preceding embodiments, deriving said indicators can include at least one of citation analysis, natural language processing, entity disambiguation, organization classification, and time series analysis.

In any of the preceding embodiments, deriving said indicators can include application of a combination of citation analyses, natural language processing, entity disambiguation, organization classification, and time series analyses to said network of elements.

In any of the preceding embodiments, deriving said indicators can include using a framework to generate and validate the indicators.

In any of the preceding embodiments, n at least some of the models can be derived using an automated process.

In any of the preceding embodiments, at least some of the models can be derived using at least one metric for evaluating a utility at least one of the indicators.

In any of the preceding embodiments, the at least one designated theme can include technical emergence.

In any of the preceding embodiments, said features can include at least one of topics, funding, organizations in text, relationships between citations, relationships between technical terms, document sections, and document genre.

Any of the preceding embodiments can further include accepting a nomination query from a user, extracting features from said knowledgebase based on said query, using said indicators and models to apply a scoring process to said extracted features to predict a future prominence of at least one entity related to said query, and providing said prediction to said user. And in some of these embodiments the extracted features include properties of elements in the heterogeneous network relating to at least one of terminology, patent impact, paper impact, persons, and organizations. Other of these embodiments further include g providing an explanation of said prediction to said user. Still other of these embodiments further include after applying said scoring process, delivering feedback to the knowledgebase and using said feedback to improve future predictions of prominence of entities.

In any of the preceding embodiments identify network characteristics and trends can include deriving indicators from at least one of metadata and full text included in the collection of data, and using Bayesian models to combine the indicators.

And, in any of the preceding embodiments, the indicators can be derived by applying computations that include at least one of a time series and a single value.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

I claim:

1. A method for constructing a knowledgebase useful for providing analysis and predictions based on a collection of data, the method comprising:
obtaining a collection of data;
extracting features from said data, at least one of said features being extracted from full text included in said data;
applying disambiguation to said extracted features;
using said collection of data and extracted features to build a heterogeneous network of elements related to at least one designated theme; and
deriving indicators and models from said network of elements that identify network characteristics and trends characteristic of said collection of data,
wherein said collection of data, extracted features, heterogeneous network of elements, indicators, and models are configured as a knowledgebase that is suitable for providing analysis and predictions based on the collection of data.

2. The method of claim 1, wherein said collection of data includes a plurality of documents.

3. The method of claim 2, wherein the documents in the collection of data are obtained from at least one of a document repository and a document superset.

4. The method of claim 2, wherein said documents include patents and papers.

5. The method of claim 2, wherein the documents are represented in an extensible markup language (XML) format.

6. The method of claim 2, wherein the collection of data includes at least ten million documents.

7. The method of claim 1, wherein deriving said indicators includes at least one of citation analysis, natural language processing, entity disambiguation, organization classification, and time series analysis.

8. The method of claim 1, wherein deriving said indicators includes application of a combination of citation analyses, natural language processing, entity disambiguation, organization classification, and time series analyses to said network of elements.

9. The method of claim 1, wherein deriving said indicators includes using a framework to generate and validate the indicators.

10. The method of claim 1, wherein at least some of the models are derived using an automated process.

11. The method of claim 1, wherein at least some of the models are derived using at least one metric for evaluating a utility at least one of the indicators.

12. The method of claim 1, wherein the at least one designated theme includes technical emergence.

13. The method of claim 1, wherein said features include at least one of:
topics;
funding;
organizations in text;
relationships between citations;
relationships between technical terms;
document sections; and
document genre.

14. The method of claim 1, further comprising:
accepting a nomination query from a user;
extracting features from said knowledgebase based on said query;
using said indicators and models to apply a scoring process to said extracted features to predict a future prominence of at least one entity related to said query; and
providing said prediction to said user.

15. The method of claim 14, wherein said extracted features include properties of elements in the heterogeneous network relating to at least one of:
terminology;
patent impact;
paper impact;
persons; and
organizations.

16. The method of claim 14, further comprising providing an explanation of said prediction to said user.

17. The method of claim 14, further comprising, after applying said scoring process, delivering feedback to the knowledgebase and using said feedback to improve future predictions of prominence of entities.

18. The method of claim 1, wherein identify network characteristics and trends includes:
deriving indicators from at least one of metadata and full text included in the collection of data; and
using Bayesian models to combine the indicators.

19. The method of claim 1, wherein the indicators are derived by applying computations that include at least one of a time series and a single value.
